(19) United States
(12) Patent Application Publication
(10) Pub. No.: US 2015/0334677 A1
(43) Pub. Date: Nov. 19, 2015

(54) LEVERAGING WIRELESS COMMUNICATION TRAFFIC OPPORTUNISTICALLY

(71) Applicant: QUALCOMM Incorporated, Inc., San Diego, CA (US)

(72) Inventors: Milind H. Patil, Santa Clara, CA (US); Ramya Srinivasan, Campbell, CA (US); Praveen Dua, Cupertino, CA (US); Gaurav Lamba, Los Altos, CA (US)

(73) Assignee: QUALCOMM Incorporated, Inc., San Diego, CA (US)

(21) Appl. No.: 14/279,700

(22) Filed: May 16, 2014

(51) Int. Cl. H04W 64/00; H04W 4/02

(52) U.S. Cl. CPC H04W 64/00; H04W 4/025

(57) ABSTRACT

Example methods, apparatuses, or articles of manufacture are disclosed herein that may be utilized, in whole or in part, to facilitate or support one or more operations or techniques for leveraging wireless communication traffic opportunistically, such as within an indoor or like environment, for example, for use in or with a mobile communication device.

### BACKGROUND

1. Field

The present disclosure relates generally to indoor position or location estimations of mobile communication devices and, more particularly, to techniques for leveraging wireless communication traffic opportunistically for use in or with mobile communication devices.

2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance data obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless communication network. Acquired wireless signals may, for example, be processed by or at a mobile communication device, and its location may be estimated using known techniques, such as Advanced Forward Link Trilateration (AFLT), base station identification, or the like.

In an indoor environment, certain mobile communication devices may be unable to reliably receive or acquire satellite or like wireless signals to facilitate or support one or more position estimation techniques. As such, different techniques may be employed to enable indoor navigation or location services. For example, a mobile communication device located indoors may obtain a position fix by measuring ranges to three or more terrestrial wireless transmitters, such as access points positioned at known locations. Ranges may be measured, for example, by obtaining a Media Access Control identifier (MAC ID) address from wireless signals received from suitable access points and measuring one or more characteristics of received signals, such as signal strength, round trip delay, or the like. At times, an indoor location of a mobile communication device may be estimated via radio heat map signature matching, for example, in which current characteristics of wireless signals received from access points at the device are compared with expected or previously measured signal characteristics stored as heat map values in a database.

In some instances, however, such as, for example, in larger indoor or like environments with unequal or sporadic distribution or grouping of mobile communication devices (e.g., shopping malls, sport arenas, etc.), cellular or like wireless signal coverage may be less than sufficient or adequate. For example, at times, a wireless spectrum of an existing communication infrastructure may fail to cope with a surge in communication traffic due to greater activity or an increased volume of users at or around particular areas. Such an increased wireless demand at or around areas of intense wireless activity may, for example, create or contribute to wireless traffic congestion (e.g., cause congestion hotspots, etc.), tax available bandwidth in wireless communication links, or the like. As such, at times, indoor positioning or navigation capabilities of certain mobile communication devices may, for example, be less useful or possibly faulty.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process for facilitating or supporting techniques for leveraging wireless communication traffic opportunistically.

FIG. 3 is a schematic diagram illustrating features associated with an implementation of an example indoor operating environment.

FIG. 4 is a schematic diagram illustrating features associated with another implementation of an example indoor operating environment.

FIG. 5 is a flow diagram illustrating an implementation of another example process for facilitating or supporting techniques for leveraging wireless communication traffic opportunistically.

FIG. 6 is a schematic diagram illustrating features associated with yet another implementation of an example indoor operating environment.

FIG. 7 is a schematic diagram illustrating an implementation of an example computing environment associated with a wireless transmitter.

FIG. 8 is a schematic diagram illustrating an implementation of an example computing environment associated with a mobile device.

FIG. 9 is a schematic diagram illustrating an implementation of an example computing environment associated with a server.

### SUMMARY

Example implementations relate to techniques for leveraging wireless communication traffic opportunistically, such as within an indoor or like environment, for example, for use in or with a mobile communication device. In one implementation, a method may comprise acquiring, at a mobile device, at least one response message to one or more probe messages to obtain one or more measured aspects of the at least one response message; acquiring beacon signals transmitted by one or more wireless transmitters to measure a received signal strength indication (RSSI) of the acquired beacon signals and to obtain Media Access Control (MAC) addresses of the one or more wireless transmitters; and providing the RSSI, the MAC addresses, and the one or more measured aspects for use, at least in part, in computing an estimated location of the mobile device.

In another implementation, method may comprise acquiring, at a wireless transmitter, probe messages from one or more mobile devices to measure a signal characteristic of the probe messages and to obtain MAC addresses of the one or more mobile devices; and transmitting the measured signal characteristic and the MAC addresses to a network entity for computing estimates of locations of the one or more mobile devices.

In yet another implementation, an apparatus may comprise a transmitter to communicate with a communication network; and one or more processors to acquire, at a mobile device, at least one response message to one or more probe messages to obtain one or more measured aspects of the at least one response message; acquire beacon signals transmitted by one or more wireless transmitters to measure a received signal strength indication (RSSI) of the acquired beacon signals and to obtain Media Access Control (MAC) addresses of the one or more wireless transmitters; and provide, via the communication network, the RSSI, the MAC addresses, and the one or more measured aspects for use, at least in part, in computing an estimated location of the mobile device.

In yet another implementation, an apparatus may comprise means for acquiring, at a wireless transmitter, probe messages from one or more mobile devices to measure a signal characteristic of the probe messages and to obtain MAC addresses of the one or more mobile devices; and means for transmitting the measured signal characteristic and the MAC addresses to a network entity for computing estimates of locations of the one or more mobile devices. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for leveraging wireless communication traffic opportunistically, such as within an indoor or like environment, for example, for use in or with a mobile communication device. For example, as discussed below, extra wireless traffic that may exist or be present in an indoor or like environment may, for example, be used opportunistically, such as in addition to typical or regular positioning-related wireless traffic, which at times may improve or increase system or network robustness. As used herein, “mobile device,” “mobile communication device,” “wireless device,” “location-aware mobile device,” or the plural form of such terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, or the like. It should be appreciated, however, that these are merely examples of mobile devices that may be used, at least in part, to implement one or more operations or techniques for leveraging wireless communication traffic opportunistically, and that claimed subject matter is not limited in this regard. It should also be noted that the terms “position” and “location” may be used interchangeably herein.

As alluded to previously, in an indoor environment or like partially or substantially enclosed areas (e.g., urban canyons, etc.), certain mobile devices may be unable to reliably receive or acquire satellite or like wireless signals to facilitate or support one or more position estimation techniques. As such, different techniques may be employed to enable indoor navigation or location services. For example, an indoor position fix of a mobile device, such as a cellular telephone, may be obtained based, at least in part, on information gathered from various systems. One such system may comprise, for example, a wireless local access network (WLAN) communication system having a number of wireless transmitters, such as IEEE 802.11 std. Wi-Fi access points supporting communications for a number of proximate mobile devices. Here, to obtain a position fix, a mobile device may, for example, measure ranges to three or more terrestrial Wi-Fi access points positioned at known locations. Ranges may be measured, for example, by obtaining a Media Access Control (MAC) address from known Wi-Fi access points and measuring one or more signal characteristics indicative of received signal strength (e.g., received signal strength indicator (RSSI), etc.), round-trip delay times (e.g., RTT, etc.), or the like. Based, at least in part, on measured ranges, a mobile device may, for example, estimate its location by applying one or more suitable positioning techniques, such as trilateration, just to illustrate one possible implementation.

As was also indicated, in some instances, such as in larger indoor or like areas prone to wireless traffic congestion, for example, more reliable or suitable position estimations of mobile devices may suffer or otherwise be affected in some manner. Indoor or like environments with extra wireless traffic may, for example, suffer from lower end-to-end yields due, at least in part, to a larger number of positioning probes communicated within an associated wireless medium (e.g., a Wi-Fi air space, etc.). For example, a more congested wireless medium may yield insufficient or less than adequate measurement probe responses communicated by transmitting sources. In addition, a decreased availability of network bandwidth due, at least in part, to a surge in wireless traffic may, for example, preclude a wireless communication network from handling or serving a larger or otherwise suitable number of mobile devices. Accordingly, it may be desirable to develop one or more methods, systems, or apparatuses that may implement more robust indoor positioning, such as in a larger indoor or like environment prone to wireless traffic congestion, for example, by leveraging or utilizing a surge or increase in wireless traffic by various existing sources, extra or otherwise.

Thus, as will be discussed in greater detail below, in an implementation, congestion of a wireless medium due, at least in part, to various sources of wireless traffic may, for example, be advantageously utilized, at least in part, such as while designing or deploying a wireless communication network. For example, as will be seen, wireless traffic initiated by one or more mobile devices, such as in the form of positioning-related probe requests or messages to one or more proximate wireless transmitters (e.g., Wi-Fi access points, etc.) may be used, at least in part, to obtain measurements of suitable characteristics or aspects of applicable wireless signals (e.g., RSSI, RTT, etc.). As was indicated, obtained signal characteristics or aspects may, for example, be employed, at least in part, for more robust localization, such as in addition to typical or regular positioning-related wireless traffic, for example. At times, traffic initiated by one or more known wireless transmitters (e.g., beacon signals, etc.) may also be utilized, at least in part, for more robust positioning, such as, for example, in addition to or in between typical or regular positioning traffic, as will also be seen. As such, at times, wireless traffic existing or present in an indoor or like environment may, for example, be opportunistically leveraged so as to increase or positively affect robustness of a wireless communication network, enable sufficient quality of services for a wireless medium (e.g., Wi-Fi air space, etc.), increase accuracy or load handling capability of a positioning system, or the like.

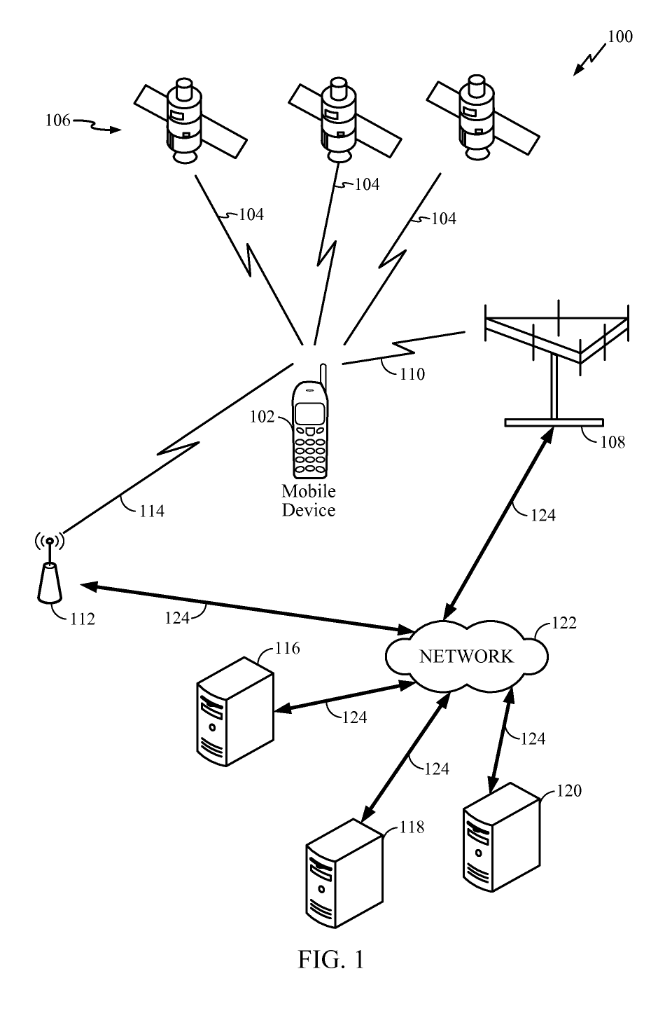

FIG. 1 is a schematic diagram illustrating features associated with an implementation of an example operating environment 100 capable of facilitating or supporting one or more processes or operations for leveraging wireless communication traffic opportunistically for use in or with a mobile device, such as a location-aware mobile device 102, for example. It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), wireless local area networks (WLAN, etc.), or the like. It should also be noted that claimed subject matter is not limited to indoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an outdoor environment.

As illustrated, in an implementation, mobile device 102 may, for example, receive or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems. In certain implementations, SPS satellites 106 may be from any one several regional navigation satellite systems (RNSS′) such as, for example, WAAS, EGNOS, QZSS, just to name a few examples.

At times, mobile device 102 may, for example, transmit wireless signals to, or receive wireless signals from, a suitable wireless communication network. In one example, mobile device 102 may communicate with a cellular communication network by transmitting wireless signals to, or receiving wireless signals from, a base station transceiver 108 over a wireless communication link 110. Similarly, mobile device 102 may transmit wireless signals to, or receive wireless signals from a local transceiver 112 over a wireless communication link 114. Base station transceiver 108, local transceiver 112, etc. may be of the same or similar type, for example, or may represent different types of devices, such as access points, radio beacons, cellular base stations, femtocells, or the like, depending on an implementation. In some instances local transceiver 112 may comprise, for example, a wireless transmitter or receiver capable of transmitting or receiving wireless signals.

In a particular implementation, local transceiver 112 may be capable of communicating with mobile device 102 at a shorter range over wireless communication link 114 than at a range established via base station transceiver 108 over wireless communication link 110. For example, local transceiver 112 may be positioned in an indoor or like environment and may provide access to a wireless local area network (WLAN, e.g., IEEE Std. 802.11 network, etc.) or wireless personal area network (WPAN, e.g., Bluetooth® network, etc.). As was indicated, at times, an indoor or like environment associated with local transceiver 112 may, for example, experience a surge or increase in wireless activity, which may create or contribute to wireless traffic congestion (e.g., cause congestion hotspots, etc.), tax available bandwidth in wireless communication links, or the like. In another example implementation, local transceiver 112 may comprise a femtocell transceiver capable of facilitating communication via link 114 according to a suitable cellular or like wireless communication protocol. Of course, it should be understood that these are merely examples of networks that may communicate with mobile device 102 over a wireless link, and claimed subject matter is not limited in this respect. For example, in some instances, operating environment 100 may include a larger number of base station transceivers 108, local transceiver 112, etc.

In an implementation, base station transceiver 108, local transceiver 112, etc. may communicate with servers 116, 118, or 120 over a network 122 via one or more links 124. Network 122 may comprise, for example, any combination of wired or wireless communication links. In a particular implementation, network 122 may comprise, for example, Internet Protocol (IP)-type infrastructure capable of facilitating or supporting communication between mobile device 102 and one or more servers 116, 118, 120, etc. via local transceiver 112, base station transceiver 108, etc. In another implementation, network 122 may comprise, for example cellular communication network infrastructure, such as a base station controller or master switching center to facilitate or support mobile cellular communication with mobile device 102.

In particular implementations, and as discussed below, mobile device 102 may have circuitry or processing resources capable of computing a position fix or estimated location of mobile device 102. For example, mobile device 102 may compute a position fix based, at least in part, on pseudorange measurements to four or more SPS satellites 106. Here, mobile device 102 may compute such pseudorange measurements based, at least in part, on pseudonoise code phase detections in signals 104 acquired from four or more SPS satellites 106. In particular implementations, mobile device 102 may receive from one or more servers 116, 118, or 120 positioning assistance data to aid in the acquisition of signals 104 transmitted by SPS satellites 106 including, for example, almanac, ephemeris data, Doppler search windows, just to name a few examples.

In some implementations, mobile device 102 may obtain a position fix by processing wireless signals received from one or more terrestrial transmitters positioned at known locations (e.g., base station transceiver 108, local transceiver 112, etc.) using any one of several techniques, such as, for example, AFLT, OTDOA, or the like. In these techniques, a range from mobile device 102 may, for example, be measured to three or more of terrestrial transmitters based, at least in part, on one or more reference signals transmitted by these transmitters and received at mobile device 102, as was indicated. Here, servers 116, 118, or 120 may be capable of providing positioning assistance data to mobile device 102 including, for example, locations, identities, orientations, etc. of terrestrial transmitters to facilitate one or more suitable positioning techniques (e.g., AFLT, OTDOA, etc.). At times, servers 116, 118, or 120 may include, for example, a base station almanac (BSA) indicating locations, identities, orientations, etc. of cellular base stations in one or more particular areas or regions associated with operating environment 100.

As alluded to previously, in particular environments, such as indoor or like environments (e.g., urban canyons, etc.), mobile device 102, servers 116, 118, or 120, etc. may not be capable of acquiring or processing signals 104 from a sufficient number of SPS satellites 106 so as to perform a suitable positioning technique (e.g., AFLT, OTDOA, etc.). Thus, optionally or alternatively, mobile device 102 may be capable of computing a position fix based, at least in part, on signals acquired from one or more local transmitters, such as femtocells, Wi-Fi access points, or the like. For example, mobile device 102 may obtain a position fix by measuring ranges to three or more local transceivers 112, base station transceivers 108, etc. positioned at known locations. In some implementations, mobile device 102 may, for example, obtain an indoor position fix by applying characteristics of acquired signals to a radio context parameter map indicating expected RSSI, RTT, or like signatures at particular locations in an indoor or like area or interest, as was also indicated.

In an implementation, mobile device 102 may, for example, receive positioning assistance data for one or more indoor positioning operations from servers 116, 118, or 120. At times, positioning assistance data may include, for example, locations, identities, orientations, etc. of one or more local transceivers 112, base station transceivers 108, etc. positioned at known locations for measuring ranges to these transmitters based, at least in part, on a measured RSSI, RTT, or the like. In some instances, positioning assistance data to aid indoor positioning operations may include, for example, radio context parameter maps, routeability graphs, etc., just to name a few examples. Other assistance data received by mobile device 102 may include, for example, electronic digital maps of indoor or like areas for display or to aid in navigation. A map may be provided to mobile device 102 as it enters a particular area, for example, and may show applicable features such as doors, hallways, entry ways, walls, etc., points of interest, such as bathrooms, pay phones, room names, stores, or the like. By obtaining a digital map of an indoor or like area of interest, mobile device 102 may, for example, be capable of overlaying its current location over the displayed map of the area so as to provide an associated user with additional context, frame of reference, or the like. The terms “positioning assistance data” and “navigation assistance data” may be used interchangeably herein.

According to an implementation, mobile device 102 may access indoor navigation assistance data via servers 116, 118, or 120 by, for example, requesting such data through selection of a universal resource locator (URL). In particular implementations, servers 116, 118, or 120 may be capable of providing indoor navigation assistance data to cover many different indoor areas including, for example, floors of buildings, wings of hospitals, terminals at an airport, portions of a university campus, areas of a large shopping mall, just to name a few examples. Also, if memory or data transmission resources at mobile device 102 make receipt of indoor positioning assistance data for all areas served by servers 116, 118, or 120 impractical or infeasible, a request for such data from mobile device 102 may, for example, indicate a rough or course estimate of a location of mobile device 102. Mobile device 102 may then be provided indoor navigation assistance data covering, for example, one or more areas including or proximate to a roughly estimated location of mobile device 102.

In some embodiments, one or more positioning techniques, such as, for example, probabilistic positioning or other techniques may be used, in whole or in part, in association with one or more context maps to obtain a position fix of mobile device 102. For example, one or more methods that may be used, at least in part, with signal signatures of a wireless environment may be applied to one or more sensor measurements, sensor signatures, sensor signals, context or social data, etc. as represented by one or more context maps. For example, in an implementation, a radio heat map may associate identities of one or more base station transceivers 108, local transceivers 112, etc. (e.g., a MAC address, etc.) with expected signal signatures, means or standard deviations from these expected signal signatures, etc. It should be understood, however, that these are merely examples of a context or radio heat map, and that claimed subject matter is not limited in this respect. In some embodiments, one or more filters, such as a particle filter, for example, may be used, at least in part, to perform one or more applicable positioning operations or techniques.

Even though a certain number of computing platforms or devices are illustrated herein, any number of suitable computing platforms or devices may be implemented to facilitate or support one or more techniques or processes associated with operating environment 100. For example, at times, network 122 may be coupled to one or more wired or wireless communication networks (e.g., WLAN, etc.) so as to enhance a coverage area for communications with mobile device 102, one or more base station transceivers 108, local transceiver 112, servers 116, 118, 120, or the like. In some instances, network 122 may facilitate or support femtocell-based operative regions of coverage, for example. Again, these are merely example implementations, and claimed subject matter is not limited in this regard.

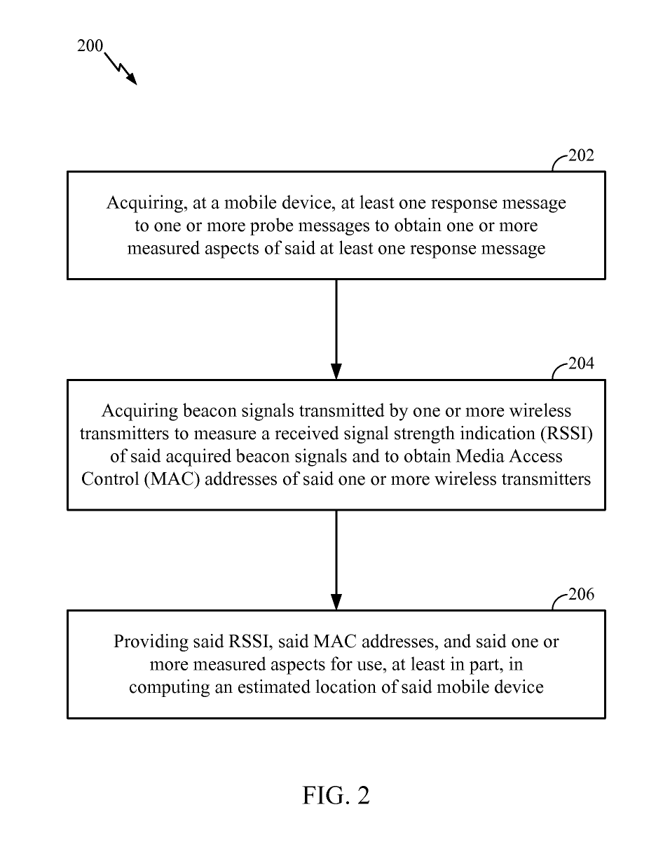

With this in mind, attention is now drawn to FIG. 2, which is a flow diagram illustrating an implementation of an example process 200 that may be performed, in whole or in part, to facilitate or support one or more operations or techniques for leveraging wireless communication traffic opportunistically for use in or with a location-aware mobile device, such as mobile device 102 of FIG. 1, for example. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

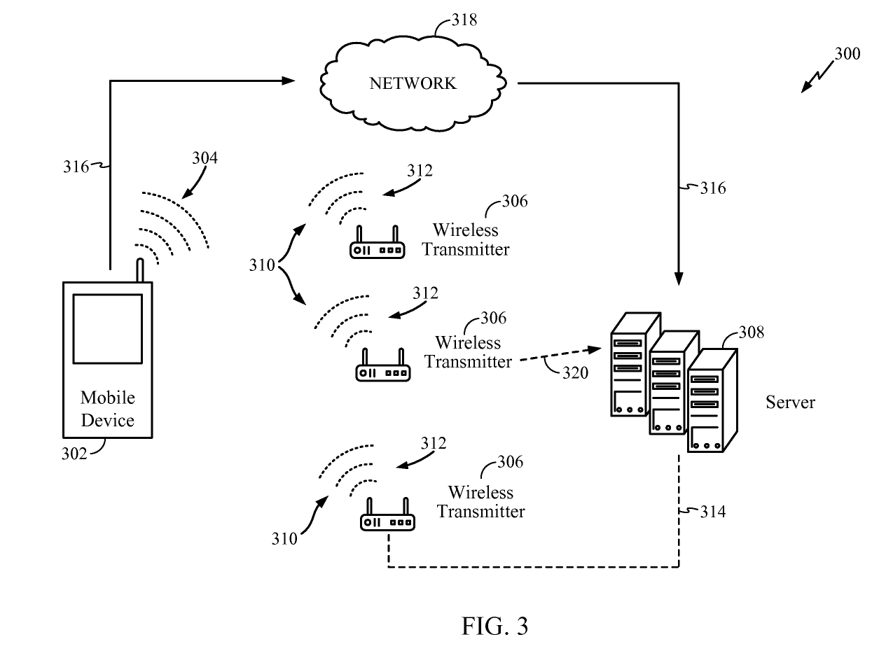

Example process 200 may, for example, begin at operation 202 with acquiring, at a mobile device, at least one response message to one or more probe messages to obtain one or more measured aspects of the at least one response message. For example, as illustrated in a schematic diagram of an example indoor operating environment 300 of FIG. 3, at times, a mobile device 302 may be capable of communicating one or more probe messages, as indicated generally via an arrow at 304, to one or more wireless transmitters 306 according to one or more communication protocols. In some instances, mobile device 302 may, for example, communicate according to an IEEE std. 802.11x communication protocol, just to illustrate one possible implementation. Claimed subject matter is not so limited, of course. As was indicated, mobile device 302 may have a uniquely assigned MAC address, which may, for example, be included in one or more probe messages 304. A MAC address may be decoded at or by one or more wireless transmitters 306, for example, or any suitable server, such as a network server 308, and may be used, at least in part, to uniquely identify mobile device 302, such as by demodulating an acquired wireless signal using one or more appropriate techniques.

At times, in response to one or more probe messages 304, one or more wireless transmitters 306 may communicate at least one response message, as illustrated generally at 310. Response message 310 may, for example, be used, at least in part, by mobile device 302 or network server 308 to obtain one or more measured aspects associated with a wireless signal of such a response message. More specifically, here, one or more measured aspects may, for example, be obtained by performing one or more active measurements with respect to response message 310 at or by mobile device 302 using one or more appropriate techniques. For example, in some instances, such as if one or more wireless transmitters 306, via response message 310, emits a relatively consistent location-dependent characteristic or exhibits a relatively consistent processing delay, a respective RSSI or RTT measurement may, for example, be obtained or collected. For example, in a particular implementation, mobile device 302 may measure a signal RTT to one or more wireless transmitters 306 by transmitting IEEE std. 802.11 probe requests and measuring time until a response message is received. Of course, claimed subject matter is not limited to a particular measured aspect or communication protocol. As alluded to previously, these or other like communications may comprise or be representative of, for example, typical or regular wireless traffic that may exist or be present in operating environment 300 and may be used, at least in part, to facilitate or support dedicated positioning of mobile device 302 via one or more appropriate techniques (e.g., trilateration, etc.).

Referring back to process 200 of FIG. 2, at operation 204, beacon signals transmitted by one or more wireless transmitters may be acquired to measure, for example, RSSI and to obtain MAC addresses of the one or more wireless transmitters. For example, as further illustrated in FIG. 3, in response to one or more probe messages 304, one or more wireless transmitters 306 may transmit respective beacon signals, indicated generally at 312, at any suitable time interval (e.g., every 100.0 milliseconds, etc.). A transmission frame (e.g., a unicast packet, etc.) of beacon signals 312 may include any suitable details with respect to wireless transmitters 306, such as, for example, transmission power, MAC address, number of chains involved, or the like. These or other appropriate details may, for example, be obtained by mobile device 302 with respect to any “visible” wireless transmitters 306 positioned within operating environment 300, such as transmitters from which beacon signals 312, response message 310, etc. may be received or otherwise observed at a receiver of mobile device 302. It should be noted that in certain implementations, instead of or in addition to RSSI, one or more other suitable signal characteristics (e.g., RTT, etc.) associated with beacon signals 312 may, for example, be measured or obtained.

In some instances, a suitable signal characteristic may, for example, be measured upon receipt of a location request communicated via one or more wireless transmitters 306. For example, in some instances, a location request may originate at network server 308, such as via a communication link 314, and may be forwarded or transmitted to mobile device 302 via one or more wireless transmitters 306, just to illustrate one possible implementation. At times, mobile device 302 may, for example, be provided with a capability (e.g., programmed with instructions, etc.) to accumulate or aggregate one or more measured signal characteristics (e.g., RSSI, etc.) of one or more acquired beacon signals 312 for a certain duration of time, such as before providing them to network server 308, as discussed below. Here, accumulation or aggregation time may be determined, at least in part, experimentally and may be pre-defined or configured, for example, or otherwise dynamically defined in some manner depending on a particular indoor or like environment, wireless medium, mobile device, wireless transmitter, communication protocol, or the like. At times, these communications may comprise or be representative, for example, of extra wireless traffic that may exist or be present in indoor or like operating environment 300, such as in addition to traffic discussed in connection with operation 202, for example. Claimed subject matter is not so limited, of course. For example, in some instances, extra wireless traffic discussed herein may comprise or be part of regular or typical wireless traffic, for example, or vice versa, which may depend on an environment, wireless medium, communication protocol, context, or the like.

Continuing now again with process 200 of FIG. 2, at operation 206, the RSSI, the MAC addresses, and the one or more measured aspects may, for example, be provided for use, at least in part, in computing an estimated location of the mobile device. For example, in some instances, the RSSI, MAC addresses, and one or more measured aspects may, for example, be provided to a suitable network server via one or more wired or wireless communication links. As particularly seen in FIG. 3, RSSI, MAC addresses of wireless transmitters 306, measured aspects, etc. may, for example, be provided to network server 308 by transmitting signals, wireless or otherwise, over one or more communication links 316, which may include a communication network 318. Network 318 may comprise, for example, any suitable wired or wireless communication network or any combination thereof. In at least one implementation, network 318 may comprise, for example, a backhaul network, though claimed subject matter is so not limited. For example, in some instances, a core network, backbone network, etc. may be employed, at least in part. At times, RSSI, MAC addresses of wireless transmitters 306, measured aspects, etc. may, for example, be provided to network server 308 in response to a location request, such as discussed above, for example, though claimed subject matter is also not so limited. For example, at times a position fix may be computed, at least in part, on mobile device 302.

As illustrated via a communication link at 320, optionally or alternatively, RSSI, MAC addresses of wireless transmitters 306, measured aspects, etc. may be forwarded to network server 308 via any suitable wireless transmitter that may, for example, be associated with network 318, network server 308, operating environment 300, or the like. Network server 308 may then combine appropriate measurements (e.g., RSSI, etc.) with other applicable measurements, inferences (e.g., a rough location, etc.), or attributes of an acquired signal so as to compute an estimated location of mobile device 302 using one or more appropriate techniques (e.g., AFLT, etc.). Accordingly, as illustrated, at least some measurements, aspects, etc. associated with extra wireless traffic may, for example, be obtained and used, at least in part, in addition to or in between measurements, aspects, etc. of typical or regular positioning-related traffic. This may, for example, allow for more robust positioning, more precise localization, improved motion models, or the like. Some non-limiting examples of benefits that may be obtained via leveraging wireless traffic opportunistically, for example, will be discussed in greater detail below.

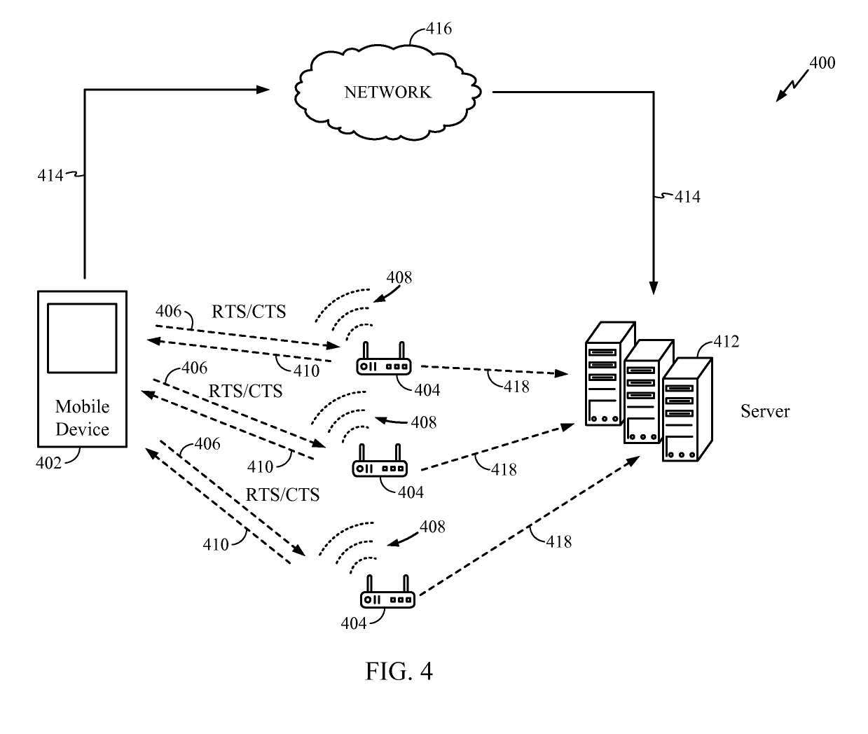

In some instances, to enhance or improve system or network robustness, one or more back-end positioning-related processes, such as performed on or at a mobile device, for example, may be used, at least in part, instead of or in addition to one or more processes or operations discussed above in connection with FIGS. 2-3. At times, these one or more back-end positioning-related processes may, for example, also facilitate or support improving or reducing data frame or packet collisions due, at least in part, to an increased number of sources (e.g., mobile devices, wireless transmitters, etc.) at or around areas of intense wireless activity (e.g., congestion hotspots, etc.). Thus, as further illustrated in a schematic diagram of an example indoor operating environment 400 of FIG. 4, at times, a positioning-related probe, such as a location request may, for example, originate from an application or process on a mobile device 402, which may be communicated to one or more wireless transmitters 404 according to one or more communication protocols. As discussed below, during these or like communications, mobile device 402 may, for example, measure one or more signal characteristics of an acquired signal received in response to a positioning-related probe from one or more wireless transmitters 404. Again, it should be noted that operating environment 400 (e.g., wireless transmitters, mobile device, etc.) may comprise, for example, or be part of operating environment 300 of FIG. 3 (e.g., wireless transmitters, mobile device, etc.), or the like.

In a particular implementation, a host application or process may prompt mobile device 402 to transmit one or more probe requests 406 via a request-to-send (RTS) frame, for example, and may measure a location-dependent signal characteristic in a response message 408 from one or more wireless transmitters 408. As seen, at times, response message 408 may, for example, be communicates via a clear-to-send (CTS) frame 410, such as in response to RTS 406. Here, RSSI or other suitable measurements or data (e.g., MAC addresses, etc.) of acquired CTS signals 410 may, for example, be collected or provided to a host application or process to be combined with other applicable measurements or data for computing an estimated location of mobile device 402. At times, applicable measurements or data may, for example, be forwarded by mobile device 402 to a network server 412, such as to compute a position fix, via one or more communication links 414, which may include a suitable network 416 (e.g., backhaul, etc.). Optionally or alternatively, applicable measurements or data, such as based, at least in part, on RTS/CTS communications performed via mobile device 402, for example, may be forwarded to network server 412 by one or more associated wireless transmitters 404 via communication links 418. As such, wireless traffic for one or more back-end positioning-related processes (e.g., extra traffic, etc.) may, for example, be used, at least in part, as an enhancement to typical or regular positioning-related wireless traffic. For example, here, a position fix of mobile device 402 may be computed based, at least in part, on positioning-related processes already performed on or by mobile device 402, such as in connection with an RTS/CTS networking protocol.

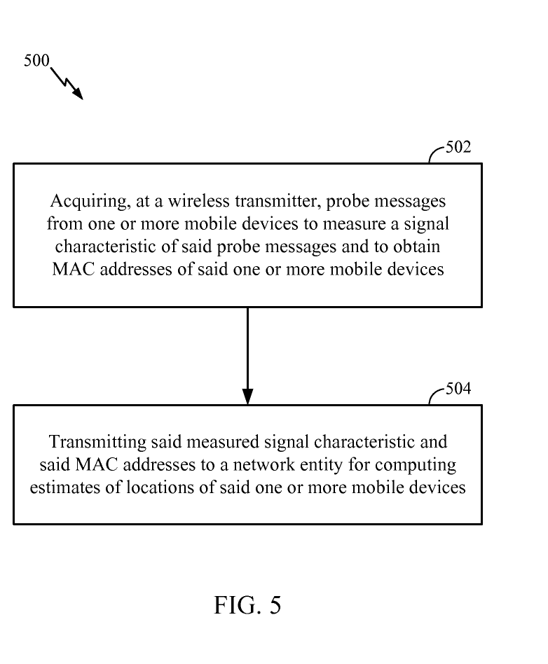

Attention is now drawn to FIG. 5, which is a flow diagram illustrating an implementation of another example process 500 that may be performed, in whole or in part, to facilitate or support one or more operations or techniques for leveraging wireless communication traffic opportunistically for use in or with a location-aware mobile device, such as mobile device 102 of FIG. 1, for example. It should be noted that information acquired or produced, such as, for example, input signals, output signals, operations, results, etc. associated with example process 500 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 500 may, for example, begin at operation 502 with acquiring, at a wireless transmitter, probe messages from one or more mobile devices to measure a signal characteristic of the probe messages and to obtain MAC addresses of the one or more mobile devices. By way of explanation, in a typical indoor or like environment, there may be a number of various mobile devices, such as devices subscribing to an associated cellular or like wireless communication network or indoor location service, for example, as well as devices not subscribing to an associated network or location service. These subscribing and non-subscribing mobile devices may, for example, initiate or generate various types or amounts of wireless traffic with respect to proximate communication sources (e.g., wireless transmitters, other mobile devices, etc.). For example, to obtain or update a position fix, non-subscribing mobile devices may probe one or more nearby wireless transmitters relatively often, which may increase existing wireless traffic within an associated wireless medium. Subscribing mobile devices may probe nearby wireless transmitters less often, such as in connection with typical or regular positioning-related communications, for example. At times, regular or dedicated probing may, for example, be less than sufficient or suitable for an accurate or otherwise suitable position fix. Thus, in some instances, wireless traffic generated by non-subscribing mobile devices may, for example, be augmented with typical or regular positioning-related traffic of subscribing mobile devices, as discussed below. At times, this may, for example, improve localization of mobile devices, enhance robustness of a positioning system, or the like.

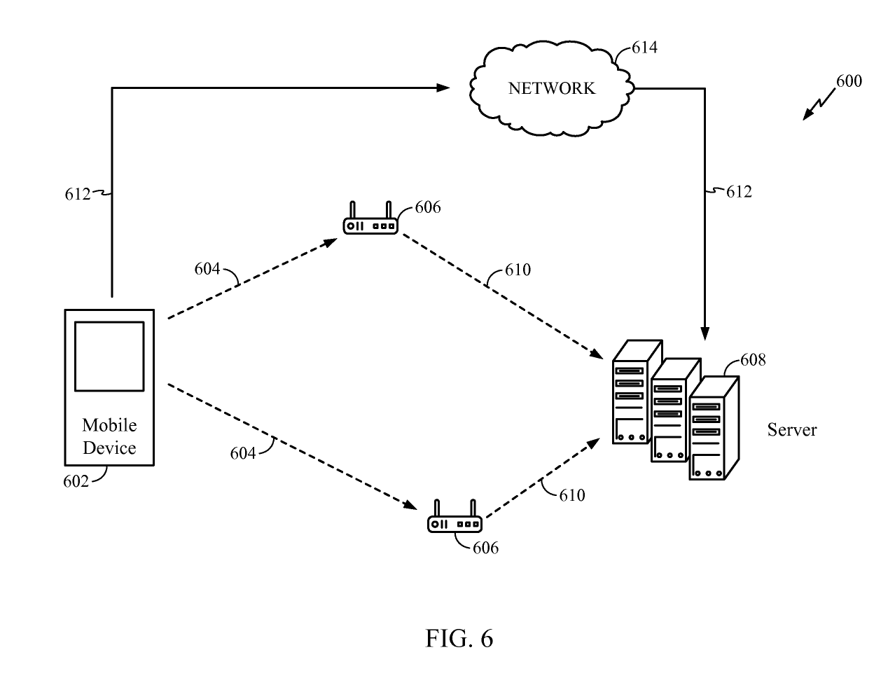

FIG. 6 is another implementation of a schematic diagram of an example indoor operating environment 600 capable of facilitating or supporting one or more processes or operations for leveraging wireless communication traffic opportunistically. Likewise, it should be noted that operating environment 600 (e.g., wireless transmitters, mobile device, etc.) may comprise, for example, or be part of operating environment 300 of FIG. 3, operating environment 400 of FIG. 4 (e.g., wireless transmitters, mobile device, etc.), or the like, or any combination thereof. As illustrated, here, a mobile device 602, subscribing or otherwise, may, for example, transmit one or more probe messages 604 that may be acquired by one or more proximate wireless transmitters 606. Based, at least in part, on probe messages 604, one or more wireless transmitters 606 may, for example, measure one or more characteristics of an acquired signal and may obtain a MAC address of mobile device 602, such as using one or more techniques discussed above. Depending on an implementation, a measured signal characteristic may comprise, for example, RSSI, RTT, or the like, or any combination thereof, as was also indicated. Although not shown, in the context of RTT, a suitable RTS packet may, for example, be transmitted between one or more wireless transmitters 606 and mobile device 602 so as to elicit an appropriate response via a CTS frame from which an applicable RTT measurement may be obtained or derived.

Referring back to process 500 of FIG. 5, at operation 504, the measured signal characteristic, such as RSSI, for example, and the obtained MAC address of the one or more mobile devices may, for example, be transmitted to a suitable network entity for computing estimates of locations of these one or more mobile devices. Here, any suitable communication protocol may be used. For example, in at least one implementation, a network services protocol, such as an IEEE std. 802.11x communication protocol, may be used, at least in part, or otherwise considered, though claimed subject matter is not so limited. A network entity may comprise, for example, a network server, a mobile device, a third-party server, such as a server not associated with a communication network, network server, etc. of an indoor or like environment, or the like, or any combination thereof.

As further illustrated in FIG. 6, a measured signal characteristic, MAC address of mobile device 602, or any other suitable data may, for example, be transmitted or forwarded by one or more wireless transmitters 606 to a network server 608, such as via one or more communication links 610. Although not shown, at times, one or more communication links 610 may include, for example, or be associated with any suitable communication network (e.g., backhaul, etc.). Optionally or alternatively, MAC address of mobile device 602, or any other suitable data may, for example, be transmitted or forwarded to network server 608 by mobile device 602, such as via a communication link 612. Likewise, communication links 612 may comprise, for example, or be associated with any suitable communication network, indicated at 614 (e.g., backhaul, etc.). Based, at least in part, on a transmitted or forwarded data, a network entity, such as network server 608, for example, may compute an estimated location of mobile device 602 using one or more appropriate techniques (AFLT, etc.). In some instances, such as if mobile device 602 comprises or is representative of a non-subscribing mobile device, for example, one or more measured signal characteristics of probe messages 604 may be used, at least in part, to compute its position fix, such as without any augmentation with or by positioning-related data (e.g., dedicated, etc.). For a subscribing mobile device, one or more measured signal characteristics of probe messages 604 may, for example, be augmented and used, at least in part, for more robust positioning. For example, if mobile device 602 comprises or is representative of a subscribing mobile device, one or more measured signal characteristics of probe messages 604 may be combined with more frequent (e.g., extra, etc.) measurements from non-subscribing mobile devices, such as to be used, at least in part, in addition to or in between regular or dedicated positioning traffic-related signal measurements. At times, this may, for example, increase position fix yield, position fix frequency, develop or introduce smoother motion models, or the like, as was indicated. In some instances, appropriate measurements may, for example, be augmented at or by a suitable server, such as network server 608, just to illustrate one possible implementation. Of course, these are merely details relating to augmenting positioning-related signal measurements, and claimed subject matter is not so limited.

Accordingly, as discussed herein, leveraging wireless communication traffic opportunistically may provide benefits. For example, one or more operations or processes described above may aid in improving motion models, such as by aggregating existing measurements along with or in between scheduled positioning-related probes. In addition, a change in a signal characteristic, such as RSSI, for example, from different beacon signals over time may provide an indication if a recipient mobile device is stationary, slow moving, or fast moving. Also, leveraging existing signaling may, for example, increase load handling capability or capacity of a positioning system, improve network access, or the like, as was indicated. Utilization of existing wireless traffic may also free available network bandwidth, such that fewer dedicated positioning-related measurements may be needed or useful, which in turn may allow for a larger number of mobile devices to be served by a positioning system. Also, based, at least in part, on a quantity or amount of existing or available wireless traffic, a number of packets used for subsequent location requests may, for example, be adaptively or dynamically adjusted or utilized.

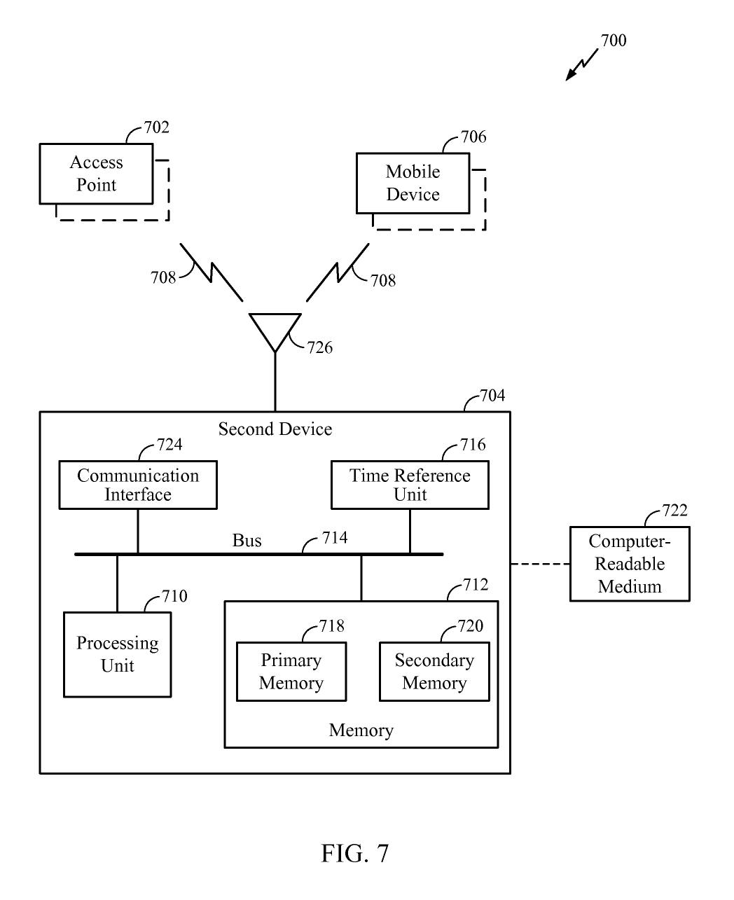

FIG. 7 is a schematic diagram illustrating an implementation of an example computing environment 700 that may include one or more computing devices capable of implementing or supporting one or more operations or processes for leveraging wireless communication traffic opportunistically, such as discussed above in connection with FIGS. 1-6, for example. A times, computing environment 700 may include, for example, a number of wireless transmitters, such as IEEE 802.11 std. Wi-Fi access points 702 and 704, for example, and a mobile device 706, which may be operatively coupled together via a wireless communication network, as illustrated generally via links at 708. Associated computing devices may be representative of any device, appliance, platform, or machine that may be capable of exchanging information over one or more communications networks in accordance with example implementations described herein.

In an implementation, a wireless communication network may be representative of one or more communication links, processes, or resources capable of supporting an exchange of information between at least two of access point 702, access point 704, or mobile device 706. By way of example but not limitation, a wireless communication network may include one or more wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via dashed lined boxes partially obscured by access point 702 or mobile device 706, there may be additional or like devices operatively coupled to a wireless communication network. It is also recognized that all or part of various devices or networks shown in computing environment 700, or processes or methods, as described herein, may be implemented using or otherwise including hardware, firmware, software, or any combination thereof.

By way of example but not limitation, access point 704 may include at least one processing unit 710 that may be operatively coupled to a memory 712 via a bus 714. Processing unit 710 may be representative of one or more circuits capable of performing at least a portion of a suitable computing procedure or process. For example, processing unit 710 may include one or more processors, controllers, microprocessors, microcontrollers, application specific integrated circuits, digital signal processors, programmable logic devices, field programmable gate arrays, or the like, or any combination thereof. As also illustrated, access point 704 may include, for example, a time reference unit 716 that may facilitate or support labeling of one or more timestamps, such as to discern a distance a signal has traveled, for example, clock synchronization between measuring units, distributing time from a central source, or the like. In some implementations, time reference unit 716 may be at least partially integrated with a suitable processing unit, such as processing unit 710, for example, though claimed subject matter is not so limited.

In certain implementations, processing unit 710 may comprise, for example, or be representative of means for acquiring, at a wireless transmitter, probe messages from one or more mobile devices to measure a signal characteristic of the probe messages and to obtain MAC addresses of the one or more mobile devices; and means for transmitting the measured signal characteristic and the MAC addresses to a network entity for computing estimates of locations of the one or more mobile devices, as illustrated in or described with respect to operations 502-504 of FIG. 5.

Memory 712 may be representative of any information storage mechanism or appliance. Memory 712 may include, for example, a primary memory 718 and a secondary memory 720. Primary memory 718 may include, for example, a random access memory, read only memory, etc. While illustrated in this example as being separate from processing unit 710, it should be understood that all or part of primary memory 718 may be provided within or otherwise co-located/coupled with processing unit 710. Secondary memory 720 may include, for example, same or similar type of memory as primary memory or one or more information storage devices or systems, such as, for example, a disk drive, an optical disc drive, a tape drive, a solid state memory drive, etc. In certain implementations, secondary memory 720 may be operatively receptive of, or otherwise configurable to couple to, a computer-readable medium 722. Computer-readable medium 722 may include, for example, any non-transitory storage medium that may carry or make accessible information, code, or instructions for one or more of devices in computing environment 700. Computer-readable medium 722 may also be referred to as a storage medium.

Access point 704 may include, for example, a communication interface 724 that may provide for or otherwise support an operative coupling of access point 704 to a wireless communication network at least through an antenna 726. By way of example but not limitation, communication interface 724 may include a network interface device or card, a modem, a router, a switch, a transceiver, and the like. Although not shown, access point 704 may also include, for example, an input/output device. An input/output device may be representative of one or more devices or features that may be configurable to accept or otherwise introduce human or machine inputs, or one or more devices or features that may be capable of delivering or otherwise providing for human or machine outputs. By way of example but not limitation, an input/output device may include an operatively configured display, speaker, keyboard, mouse, trackball, touch screen, data port, or the like.

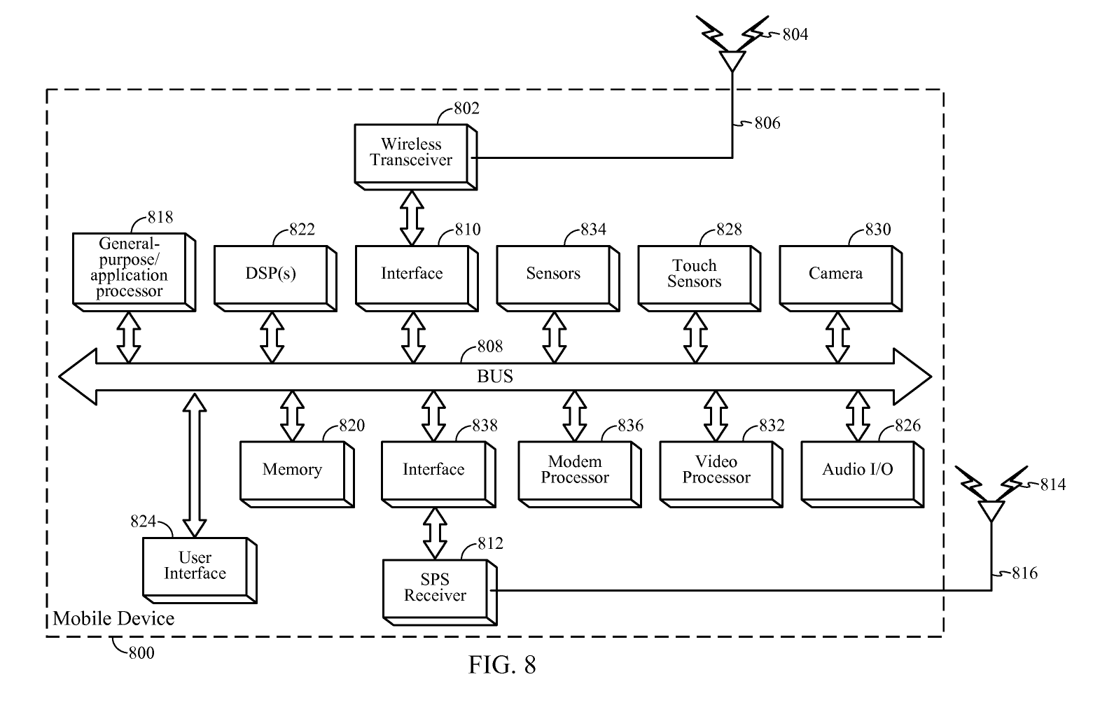

FIG. 8 is a schematic diagram of an implementation of an example computing environment associated with a mobile device that may be used, at least in part, to facilitate or support one or more operations or techniques for leveraging wireless communication traffic opportunistically, such as in a larger indoor or like environment prone to wireless traffic congestion, for example. An example computing environment may comprise, for example, a mobile device 800 that may include one or more features or aspects of respective mobile devices 102, 302, 402, or 602 of FIG. 1, 3, 4, or 6, though claimed subject matter is not so limited. For example, in some instances, mobile device 800 may comprise a wireless transceiver 802 capable of transmitting or receiving wireless signals, referenced generally at 804, such as via an antenna 806 over a suitable wireless communication network. Wireless transceiver 802 may, for example, be capable of sending or receiving one or more suitable communications, such as one or more communications discussed with reference to FIGS. 1-6 (e.g., probe messages, RTS/CTS packets, etc.), as one possible example.

Wireless transceiver 802 may, for example, be coupled or connected to a bus 808 via a wireless transceiver bus interface 810. Depending on an implementation, at times, wireless transceiver bus interface 810 may, for example, be at least partially integrated with wireless transceiver 802. Some implementations may include multiple wireless transceivers 802 or antennas 806 so as to enable transmitting or receiving signals according to a corresponding multiple wireless communication standards such as Wireless Fidelity (WiFi), Code Division Multiple Access (CDMA), Wideband-CDMA (W-CDMA), Long Term Evolution (LTE), Bluetooth®, just to name a few examples.

In an implementation, mobile device 800 may, for example, comprise an SPS or like receiver 812 capable of receiving or acquiring one or more SPS or other suitable wireless signals 814, such as via an SPS or like antenna 816. SPS receiver 812 may process, in whole or in part, one or more acquired SPS signals 814 for estimating a location, coarse or otherwise, of mobile device 800. In some instances, one or more general-purpose application processors 818, memory 820, digital signal processor(s) (DSP) 822, or like specialized devices or processors not shown may be utilized to process acquired SPS signals 814, in whole or in part, calculate a location of mobile device 800, such as in conjunction with SPS receiver 812, or the like. Storage of SPS or other signals for implementing one or more positioning operations, such as in connection with one or more techniques for leveraging wireless communication traffic opportunistically, for example, may be performed, at least in part, in memory 820, suitable registers or buffers (not shown). Although not shown, it should be appreciated that in at least one implementation one or more processors 818, memory 820, DSPs 822, or like specialized devices or processors may comprise one or more processing modules capable of acquiring at least one response message to one or more probe messages to obtain one or more measured aspects of the at least one response message; acquiring beacon signals transmitted by one or more wireless transmitters to measure RSSI of the acquired beacon signals and to obtain Media Access Control (MAC) addresses of the one or more wireless transmitters; and providing the RSSI, the MAC addresses, and the one or more measured aspects for use, at least in part, in computing an estimated location of the mobile device. It should also be noted that all or part of one or more processing modules may be implemented using or otherwise including hardware, firmware, software, or any combination thereof.

As illustrated, DSP 822 may be coupled or connected to processor 818 and memory 820 via bus 808. Although not shown, in some instances, bus 808 may comprise one or more bus interfaces that may be integrated with one or more applicable components of mobile device 800, such as DSP 822, processor 818, memory 820, or the like. In various embodiments, one or more operations or functions described herein may be performed in response to execution of one or more machine-readable instructions stored in memory 820, such as on a computer-readable storage medium, such as RAM, ROM, FLASH, disc drive, etc., just to name a few examples. Instructions may, for example, be executable via processor 818, one or more specialized processors not shown, DSP 822, or the like. Memory 820 may comprise a non-transitory processor-readable memory, computer-readable memory, etc. that may store software code (e.g., programming code, instructions, etc.) that may be executable by processor 818, DSP 822, or the like to perform operations or functions described herein.

Mobile device 800 may comprise a user interface 824, which may include any one of several devices such as, for example, a speaker, microphone, display device, vibration device, keyboard, touch screen, etc., just to name a few examples. In at least one implementation, user interface 824 may enable a user to interact with one or more applications hosted on mobile device 800. For example, one or more devices of user interface 824 may store analog or digital signals on memory 820 to be further processed by DSP 822, processor 818, etc. in response to input or action from a user. Similarly, one or more applications hosted on mobile device 800 may store analog or digital signals in memory 820 to present an output signal to a user. In some implementations, mobile device 800 may optionally include a dedicated audio input/output (I/O) device 826 comprising, for example, a dedicated speaker, microphone, digital to analog circuitry, analog to digital circuitry, amplifiers, gain control, or the like. It should be understood, however, that this is merely an example of how audio I/O device 826 may be implemented, and that claimed subject matter is not limited in this respect. As seen, mobile device 800 may comprise one or more touch sensors 828 responsive to touching or like pressure applied on a keyboard, touch screen, or the like.

In an implementation, mobile device 800 may comprise, for example, a camera 830, dedicated or otherwise, such as for capturing still or moving imagery, or the like. Camera 830 may comprise, for example, a camera sensor or like imaging device (e.g., charge coupled device, complementary metal oxide semiconductor (CMOS)-type imager, etc.), lens, analog to digital circuitry, frame buffers, etc., just to name a few examples. In some instances, additional processing, conditioning, encoding, or compression of signals representing one or more captured images may, for example, be performed, at least in part, at processor 818, DSP 822, or the like. Optionally or alternatively, a video processor 832, dedicated or otherwise, may perform conditioning, encoding, compression, or manipulation of signals representing one or more captured images. Additionally, video processor 832 may, for example, decode or decompress one or more stored images for presentation on a display (not shown) of mobile device 800.

Mobile device 800 may comprise one or more sensors 834 coupled or connected to bus 808, such as, for example, one or more inertial sensors, ambient environment sensors, or the like. Inertial sensors of sensors 834 may comprise, for example, one or more accelerometers (e.g., collectively responding to acceleration of mobile device 800 in one, two, or three dimensions, etc.), gyroscopes or magnetometers (e.g., to support one or more compass or like applications, etc.), etc., just to illustrate a few examples. Ambient environment sensors of mobile device 800 may comprise, for example, one or more barometric pressure sensors, temperature sensors, ambient light detectors, camera sensors, microphones, etc., just to name few examples. Sensors 834 may generate analog or digital signals that may be stored in memory 820 and may be processed by DSP 822, processor 818, etc., such as in support of one or more applications directed to positioning or navigation operations, wireless communications, gaming or the like.

In a particular implementation, mobile device 800 may comprise a modem processor 836, dedicated or otherwise, capable of performing baseband processing of signals received or downconverted via wireless transceiver 802, SPS receiver 812, or the like. Similarly, modem processor 836 may perform baseband processing of signals to be upconverted for transmission via wireless transceiver 802, for example. In alternative implementations, instead of having a dedicated modem processor, baseband processing may be performed, at least in part, by processor 818, DSP 822, or the like. In addition, in some instances, an interface 838, although illustrated as a separate component, may be integrated, in whole or in part, with one or more applicable components of mobile device 800, such as bus 808 or SPS receiver 812, for example. Optionally or alternatively, SPS receiver 812 may be coupled or connected to bus 808 directly. It should be understood, however, that these are merely examples of components or structures that may perform baseband processing, and that claimed subject matter is not limited in this regard.

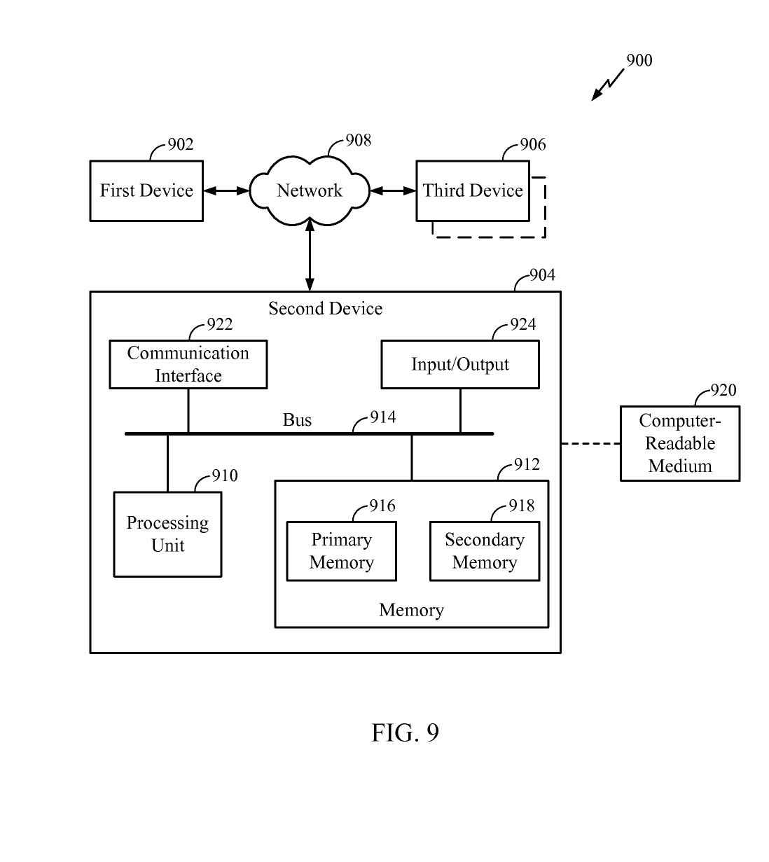

FIG. 9 is a schematic diagram illustrating an implementation of an example computing environment 900 that may include one or more servers or other devices capable of partially or substantially implementing or supporting one or more operations or processes for leveraging wireless communication traffic opportunistically, as discussed above in connection with FIGS. 1-6, for example. As was indicated, one or more servers or other devices may comprise, for example, a network server associated with a particular indoor or like area, such as server 116, 118, or 120 of FIG. 1, network server 308, 412, 608 of FIG. 3, 4, or 6, respectively, etc., a mobile device, a third-party server, such as a server not associated with a particular indoor or like area of interest, network server, etc., or any combination thereof. Thus, computing environment 900 may include, for example, a first device 902, a second device 904, a third device 906, etc., which may be operatively coupled together via a communications network 908.

First device 902, second device 904, or third device 906 may be representative of any device, appliance, platform, or machine that may be capable of exchanging information over communications network 908. By way of example but not limitation, any of first device 902, second device 904, or third device 906 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 902, 904, and 906, respectively, may comprise one or more of a mobile device, wireless transmitter, server, etc. in accordance with example implementations described herein.

In an implementation, communications network 908 may be representative of one or more communication links, processes, or resources capable of supporting an exchange of information between at least two of first device 902, second device 904, or third device 906. By way of example but not limitation, communications network 908 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 906, there may be additional like devices operatively coupled to communications network 908. It is also recognized that all or part of various devices or networks shown in computing environment 900, or processes or methods, as described herein, may be implemented using or otherwise including hardware, firmware, software, or any combination thereof.

By way of example but not limitation, second device 904 may include at least one processing unit 910 that may be operatively coupled to a memory 912 via a bus 914. Processing unit 910 may be representative of one or more circuits capable of performing at least a portion of a suitable computing procedure or process. For example, processing unit 910 may include one or more processors, controllers, microprocessors, microcontrollers, application specific integrated circuits, digital signal processors, programmable logic devices, field programmable gate arrays, or the like, or any combination thereof. Although not shown, second device 904 may include a location-tracking unit that may initiate a coarse position fix of a mobile device of interest, such as in an indoor or like area of interest, for example, based, at least in part, on one or more recently received or acquired wireless signals, such as from an SPS. In some implementations, a location-tracking unit may be at least partially integrated with a suitable processing unit, such as processing unit 910, for example, though claimed subject matter is not so limited. In certain server-based or server-supported implementations, processing unit 910 may, for example, comprise facilitating or supporting means for acquiring at least one response message to one or more probe messages to obtain one or more measured aspects of the at least one response message. In some instances, processing unit 910 may, for example, comprise facilitating or supporting means for acquiring beacon signals transmitted by one or more wireless transmitters to measure a received signal strength indication (RSSI) of the acquired beacon signals and to obtain Media Access Control (MAC) addresses of the one or more wireless transmitters. Depending on an implementation, processing unit 910 may also comprise, for example, facilitating or supporting means for using the RSSI, the MAC addresses, and the one or more measured aspects, at least in part, in computing an estimated location of a mobile device.

Memory 912 may be representative of any information storage mechanism or appliance. Memory 912 may include, for example, a primary memory 916 and a secondary memory 918. Primary memory 916 may include, for example, a random access memory, read only memory, etc. While illustrated in this example as being separate from processing unit 910, it should be understood that all or part of primary memory 916 may be provided within or otherwise co-located/coupled with processing unit 910. Secondary memory 918 may include, for example, same or similar type of memory as primary memory or one or more information storage devices or systems, such as, for example, a disk drive, an optical disc drive, a tape drive, a solid state memory drive, etc. In certain implementations, secondary memory 918 may be operatively receptive of, or otherwise capable of being coupled to, a computer-readable medium 920. Computer-readable medium 920 may include, for example, any non-transitory storage medium that may carry or make accessible information, code, or instructions for one or more of devices in computing environment 900. Computer-readable medium 920 may also be referred to as a storage medium.

Second device 904 may include, for example, a communication interface 922 that may provide for or otherwise support an operative coupling of second device 904 to at least communications network 908. By way of example but not limitation, communication interface 922 may include a network interface device or card, a modem, a router, a switch, a transceiver, and the like. Second device 904 may also include, for example, an input/output device 924. Input/output device 924 may be representative of one or more devices or features that may be configurable to accept or otherwise introduce human or machine inputs, or one or more devices or features that may be capable of delivering or otherwise providing for human or machine outputs. By way of example but not limitation, input/output device 924 may include an operatively configured display, speaker, keyboard, mouse, trackball, touch screen, information port, or the like.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform functions described herein. Any machine readable medium tangibly embodying instructions may be used in implementing methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of information as expressed by a particular state of the storage media. For example, an electronic signal representative of information may be “stored” in a portion of the storage media (e.g., memory) by affecting or changing the state of such portions of the storage media to represent information as binary information (e.g., via ones and zeros). As such, in a particular implementation, such a change of state of the portion of the storage media to store a signal representative of information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to store desired program code in the form of instructions or information structures and that may be accessed by a computer or processor thereof. Disk and disc, as used herein, includes compact disc (CD), laser disc, optical disc, digital versatile disc (DVD), floppy disk and blue-ray disc where disks usually reproduce information magnetically, while discs reproduce information optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN),a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In an implementation, a mobile device may, for example, be capable of communicating with one or more femtocells, such as for the purpose of estimating its location, communicating with a suitable server, or the like. As used herein, “femtocell” may refer to one or more smaller-size cellular base stations that may be capable of detecting a wireless signal transmitted from a mobile device using one or more appropriate techniques. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated Wi-Fi, for example. However, such details relating to femtocells are merely examples, and claimed subject matter is not so limited.

Also, if applicable, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
acquiring, at a mobile device, at least one response message to one or more probe messages to obtain one or more measured aspects of said at least one response message;
acquiring beacon signals transmitted by one or more wireless transmitters to measure a received signal strength indication (RSSI) of said acquired beacon signals and to obtain Media Access Control (MAC) addresses of said one or more wireless transmitters; and
providing said RSSI, said MAC addresses, and said one or more measured aspects for use, at least in part, in computing an estimated location of said mobile device.

2. The method of claim 1, wherein said one or more measured aspects comprises a measured round-trip time (RTT).

3. The method of claim 1, wherein said one or more measured aspects comprises a measured RSSI of said at least one response message.

4. The method of claim 1, wherein said providing said RSSI, said MAC addresses, and said one or more measured aspects further comprises transmitting said RSSI, said MAC addresses, and said one or more measured aspects to a server.

5. The method of claim 4, wherein said server comprises at least one of the following: a network server; a third-party server; or any combination thereof.

6. The method of claim 1, wherein said providing said RSSI, said MAC addresses, and said one or more measured aspects further comprises computing a position fix at said mobile device.

7. The method of claim 1, wherein said method is performed, at least in part, in response to receipt of at least one location request via said one or more wireless transmitters.

8. The method of claim 7, wherein said acquired beacon signals transmitted by said one or more wireless transmitters comprise beacon signals acquired following said receipt of said at least one location request via said one or more wireless transmitters.

9. The method of claim 1, wherein said one or more wireless transmitters comprises one or more IEEE 802.11 std. Wi-Fi access points.

10. The method of claim 1, wherein one or more of said at least one response message, said one or more probe messages, and said beacon signals are communicated in accordance with a request-to-send/clear-to-send (RTS/CTS) networking protocol.

11. The method of claim 10, wherein said RTS/CTS networking protocol is part of wireless traffic for one or more back-end positioning-related processes.

12. The method of claim 1, wherein said acquired beacon signals comprise aggregated beacon signals.

13. The method of claim 1, wherein one or more of said mobile device and said one or more wireless transmitters are located in an indoor environment.

14. A method comprising:
acquiring, at a wireless transmitter, probe messages from one or more mobile devices to measure a signal characteristic of said probe messages and to obtain MAC addresses of said one or more mobile devices; and
transmitting said measured signal characteristic and said MAC addresses to a network entity for computing estimates of locations of said one or more mobile devices.

15. The method of claim 14, wherein said measured signal characteristic and said MAC addresses are transmitted to said network entity using a network services protocol.

16. The method of claim 14, wherein said probe messages are communicated according to a request-to-send/clear-to-send (RTS/CTS) networking protocol.

17. The method of claim 14, wherein said network entity comprises at least one of the following: a network server; a third-party server; a mobile device; or any combination thereof.

18. The method of claim 14, wherein said measured signal characteristic is used, at least in part, in addition to one or more dedicated positioning traffic-related signal measurements.

19. The method of claim 14, wherein said measured signal characteristic is used, at least in part, in between one or more dedicated positioning traffic-related signal measurements.

20. The method of claim 14, wherein said measured signal characteristic comprises at least one of the following: a measured round-trip time (RTT); a received signal strength indication (RSSI); or any combination thereof.

21. The method of claim 14, wherein said one or more mobile devices comprise at least one of the following: one or more subscribing mobile devices; one or more non-subscribing mobile devices; or any combination thereof.

22. The method of claim 21, wherein said one or more subscribing mobile devices comprise mobile devices subscribing to at least one of the following: the same indoor location service; the same wireless communication network; or any combination thereof.

23. An apparatus comprising:
a transmitter to communicate with a communication network; and
one or more processors to:
acquire, at a mobile device, at least one response message to one or more probe messages to obtain one or more measured aspects of said at least one response message;
acquire beacon signals transmitted by one or more wireless transmitters to measure a received signal strength indication (RSSI) of said acquired beacon signals and to obtain Media Access Control (MAC) addresses of said one or more wireless transmitters; and
provide said RSSI, said MAC addresses, and said one or more measured aspects for use, at least in part, in computing an estimated location of said mobile device.

24. The apparatus of claim 23, wherein said one or more processors to said provide said RSSI, said MAC addresses, and said one or more measured aspects further to transmit said RSSI, said MAC addresses, and said one or more measured aspects to a server.

25. The apparatus of claim 23, wherein said one or more processors to said provide said RSSI, said MAC addresses, and said one or more measured aspects further to compute a position fix at said mobile device.

26. The apparatus of claim 23, wherein one or more of said at least one response message, said one or more probe messages, and said beacon signals are communicated in accordance with a request-to-send/clear-to-send (RTS/CTS) networking protocol.

27. The apparatus of claim 26, wherein said RTS/CTS networking protocol is part of wireless traffic for one or more back-end positioning-related processes.

28. The apparatus of claim 23, wherein said acquired beacon signals comprise aggregated beacon signals.

29. An apparatus comprising:
means for acquiring, at a wireless transmitter, probe messages from one or more mobile devices to measure a signal characteristic of said probe messages and to obtain MAC addresses of said one or more mobile devices; and
means for transmitting said measured signal characteristic and said MAC addresses to a network entity for computing estimates of locations of said one or more mobile devices.

30. The apparatus of claim 29, wherein said measured signal characteristic is used, at least in part, in addition to or in between one or more dedicated positioning traffic-related signal measurements.
